(19) United States
(12) Patent Application Publication
(10) Pub. No.: US 2026/0176149 A1
(43) Pub. Date: Jun. 25, 2026

(54) METHOD FOR MINERALIZING PERFLUORINATED COMPOUND BY USING MOLTEN ALKALI

(71) Applicant: Tongji University, Shanghai (CN)

(72) Inventors: Boran WU, Shanghai (CN); Huan ZHANG, Shanghai (CN)

(73) Assignee: Tongji University, Shanghai (CN)

(21) Appl. No.: 19/258,962

(22) Filed: Jul. 3, 2025

(30) Foreign Application Priority Data
Dec. 23, 2024 (CN) 202411902098.X

(51) Int. Cl. C01D 3/02

(52) U.S. Cl. CPC C01D 3/02

(57) ABSTRACT

A method for mineralizing a perfluorinated compound by using a molten alkali is provided. The method includes the following steps: mixing NaOH and KOH to obtain a mixed alkali, and heating the mixed alkali to a temperature of 150° C. to 300° C. to a molten state obtain a molten alkali; adding the perfluorinated compound to the molten alkali to obtain a molten reaction system, and holding the molten reaction system at the temperature of 150° C. to 300° C.; and subjecting the molten reaction system to reaction for 15 min to 60 min to mineralizing the perfluorinated compound.

### CROSS REFERENCE TO THE RELATED APPLICATIONS

This application is based upon and claims priority to Chinese Patent Application No. 202411902098.X, filed on Dec. 23, 2024, the entire contents of which are incorporated herein by reference.

### TECHNICAL FIELD

The present disclosure belongs to the technical field of environmental protection, and in particular relates to a method for mineralizing a perfluorinated compound by using a molten alkali.

### BACKGROUND

Due to the unique surface activity and thermal stability of perfluorinated compounds, the perfluorinated compounds are widely used in a variety of fields such as textiles, tableware coatings, logistics packaging and fire extinguishing. However, the perfluorinated compounds also have a plurality of biotoxicities such as carcinogenicity and teratogenicity, and recalcitrance; and will cause long-term risks of environmental pollution if not properly controlled. The transport and transformation patterns of perfluorinated compounds in environmental media and mineralization techniques for perfluorinated compounds have gradually become frontline hot-spot issues in the field of environmental remediation.

Existing destruction techniques for perfluorinated compounds include: a photocatalytic reduction method, an electrochemical method, an ultrasonic method, a mechanical force method, a plasma incineration heat treatment method, etc. Among them the photocatalytic reduction method is only suitable for light-transmissive aqueous systems, and oxygen-containing anions or oxidizing ions (such as NO₃⁻, NO₂⁻ and SO₄²⁻) co-existing in water will compete for reductive hydrated electrons, putting restrictions on the destruction efficiency of perfluorinated compounds. Complex equipment is usually required for the implementation of electrochemical, acoustochemical and mechanochemical methods, making it difficult to achieve large-scale engineering applications. Thermal techniques such as plasma incineration could effectively achieve the complete mineralization of all kinds of perfluorinated compounds, but the required temperatures are typically up to 1100° C. Therefore, complex and demanding application conditions are the main challenge for the large-scale application of such techniques.

In summary, the existing mineralization techniques for perfluorinated compounds exhibit low treatment efficiency and require harsh reaction conditions. Therefore, it is urgent to develop a new technical method with high treatment efficiency for the non-selective mineralization of perfluorinated compounds under mild reaction conditions and simple operating conditions.

### SUMMARY

An object of the present disclosure is to provide a method for mineralizing a perfluorinated compound by using a molten alkali so as to overcome the above drawbacks of conventional technology. The method exhibits a good defluorination effect on perfluorinated compounds, and has an organofluorine conversion rate of nearly 100%.

The object of the present disclosure could be achieved by the following technical solutions.

The present disclosure provides a method for mineralizing a perfluorinated compound by using a molten alkali, including the following steps:
mixing NaOH and KOH to obtain a mixed alkali, and heating the mixed alkali to a temperature of 150° C. to 300° C. to a molten state obtain a molten alkali;
adding the perfluorinated compound to the molten alkali to obtain a molten reaction system, and holding the molten reaction system at the temperature of 150° C. to 300° C.; and
subjecting the molten reaction system to reaction for 15 min to 60 min to mineralizing the perfluorinated compound.

In some embodiments, a mass fraction of NaOH in the molten alkali is in a range of 0% to 90%.

In some embodiments, the mass fraction of NaOH in the molten alkali is in a range of 10% to 90%.

In some embodiments, the perfluorinated compound is at least one selected from the group consisting of perfluorooctanesulfonic acid (PFOS), perfluorohexanesulfonic acid (PFHxS), perfluorobutanesulfonic acid (PFBS), perfluorooctanoic acid (PFOA), perfluorohexanoic acid (PFHxA) and perfluorobutanoic acid (PFBA).

In some embodiments, a mass of the perfluorinated compound is 1% to 10% of a mass of the molten alkali.

In some embodiments, the mass of the perfluorinated compound is 1% to 5% of the mass of the molten alkali.

In some embodiments, after the perfluorinated compound is completely mineralized, organofluorine is converted to NaF or KF.

In some embodiments, after the perfluorinated compound is completely mineralized, resulting solid residues are all dissolved in water, and a total amount of F⁻ based on a fluoride ion concentration is consistent with a total amount of fluorine in the perfluorinated compound before the reaction.

Compared with conventional technology, some embodiments of the present disclosure have the following beneficial effects.

(1) In the method for mineralizing the perfluorinated compound by using the molten alkali according to the present disclosure, the homolytic defluorination of a sulfonic acid functional group in the perfluorinated compound is induced to destabilize carbon-fluorine bonds, thereby mineralizing organofluorine into inorganic fluorine. The method exhibits a good defluorination effect on perfluorinated compounds, has an organofluorine conversion rate of nearly 100%, effectively achieving control over the pollution of perfluorinated compounds.

(2) The method for mineralizing the perfluorinated compound by using the molten alkali according to the present disclosure is suitable for a wide range of applications, can achieve the mineralization of both perfluorosulfonic acids and perfluorocarboxylic acids, and is applicable to both solid waste with perfluorinated compound contaminants and water-containing materials obtained from drying.

(3) The method for mineralizing a perfluorinated compound by using the molten alkali according to the present disclosure involves mild reaction conditions, substantially reduces a reaction temperature to 150° C. to 300° C. compared with conventional perfluorinated compound treatment techniques with plasma incineration as a representative, and does not need any pressure-bearing reaction equipment.

### DETAILED DESCRIPTION OF THE EMBODIMENTS

The embodiments of the present disclosure will be described in detail below. The embodiments are implemented on the premise of the technical solutions of the present disclosure, and detailed embodiments and specific operating procedures are given; however, the scope of protection of the present disclosure is not limited to the following embodiments.

The present disclosure provides a method for mineralizing a perfluorinated compound by using a molten alkali, including the following steps:
S1, mixing NaOH and KOH to obtain a mixed alkali, with a mass fraction of NaOH being 0% to 90%, preferably 10% to 90%, and heating the mixed alkali to a temperature of 150° C. to 300° C. to a molten state obtain a molten alkali;
S2, adding at least one selected from the group consisting of PFOS, PFHxS, PFBS, PFOA, PFHxA and PFBA to the molten alkali obtained in step S1, a mass of the perfluorinated compound is 1% to 10%, preferably 1% to 5%, of a mass of the molten alkali, and holding a molten reaction system at the temperature of 150° C. to 300° C.; and
S3, subjecting the molten reaction system to reaction for 15 min to 60 min to completely mineralizing the perfluorinated compound and converting organofluorine to NaF or KF.

In some specific embodiments, after the perfluorinated compound is completely mineralized, resulting solid residues are dissolved in water, and a total amount of F⁻ based on a fluoride ion concentration is consistent with a total amount of fluorine in the perfluorinated compound before the reaction.

Raw materials and equipment used in the present disclosure are all conventional raw materials and equipment in the art. In the following examples, unless otherwise specified, the raw materials or treatment techniques are conventional commercially-available raw materials or conventional treatment techniques in the art.

### Example 1

A method for mineralizing a perfluorinated compound by using a molten alkali was conducted by the following steps:
(1) NaOH was mixed with KOH to obtain a mixed alkali, with a mass fraction of NaOH being 30% and a mass fraction of KOH being 70%. The mixed alkali was heated to 150° C. to a molten state to obtain a molten alkali;
(2) 1 wt % of PFOS was added to the molten alkali obtained in step (1), and a temperature of a molten reaction system was held at the 150° C.; and
(3) the molten reaction system was subjected to reaction for 60 min, and a resulting reaction product was cooled to room temperature. All resulting residues were dissolved in 50 mL of water. A concentration of F⁻ was determined by using an F⁻ ion selective electrode, wherein a total amount of F⁻ accounts for 99.3% of a total amount of organofluorine added in step (2), i.e. 99.3% of the perfluorinated compound has been treated by mineralization.

### Example 2

A method for mineralizing a perfluorinated compound by using a molten alkali was conducted by the following steps:
(1) NaOH was mixed with KOH to obtain a mixed alkali, with a mass fraction of NaOH being 50% and a mass fraction of KOH being 50%. The mixed alkali was heated to 250° C. to a molten state to obtain a molten alkali;
(2) 1 wt % of perfluorooctanesulfonic acid PFOS, 2 wt % of perfluorohexanesulfonic acid PFHxS and 2 wt % of perfluorobutanesulfonic acid PFBS were added to the molten alkali obtained in step (1). A total mass fraction of the perfluorinated compounds was 5 wt %, and a temperature of a molten reaction system was held at the 250° C.; and
(3) the molten reaction system was subjected to reaction for 20 min, and a resulting reaction product was cooled to room temperature. All resulting residues were dissolved in 50 mL of water. A concentration of F⁻ was determined by using an F⁻ ion selective electrode, wherein a total amount of F⁻ accounts for 98.2% of a total amount of organofluorine added in step (2), i.e. 98.2% of the perfluorinated compound has been treated by mineralization.

### Example 3

A method for mineralizing a perfluorinated compound by using a molten alkali was conducted by the following steps:
(1) NaOH was mixed with KOH to obtain a mixed alkali, with a mass fraction of NaOH being 70% and a mass fraction of KOH being 30%. The mixed alkali was heated to 300° C. to a molten state to obtain a molten alkali;
(2) 1 wt % of PFBS was added to the molten alkali obtained in step (1), and a temperature of a molten reaction system was held at the 300° C.; and
(3) the molten reaction system was subjected to reaction for 60 min, and a resulting reaction product was cooled to room temperature. All resulting residues were dissolved in 50 mL of water. A concentration of F⁻ was determined by using an F⁻ ion selective electrode, wherein a total amount of F⁻ accounts for 93.5% of a total amount of organofluorine added in step (2), i.e. 93.5% of the perfluorinated compound has been treated by mineralization.

### Example 4

A method for mineralizing a perfluorinated compound by using a molten alkali was conducted by the following steps:
(1) NaOH was mixed with KOH to obtain a mixed alkali, with a mass fraction of NaOH being 20% and a mass fraction of KOH being 80%. The mixed alkali was heated to 150° C. to a molten state to obtain a molten alkali;
(2) 1 wt % of PFOA, 1 wt % of PFHxA and 1 wt % of PFBA were added to the molten alkali obtained in step (1). A total mass fraction of the perfluorinated compounds was 3 wt %, and a temperature of a molten reaction system was held at the 150° C.; and
(3) the molten reaction system was subjected to reaction for 15 min, and a resulting reaction product was cooled to room temperature. All resulting residues were dissolved in 50 mL of water. A concentration of F⁻ was determined by using an F⁻ ion selective electrode, wherein a total amount of F⁻ accounts for 99.7% of a total amount of organofluorine added in step (2), i.e. 99.7% of the perfluorinated compound has been treated by mineralization.

### Example 5

A method for mineralizing a perfluorinated compound by using a molten alkali was conducted by the following steps:
(1) NaOH was mixed with KOH to obtain a mixed alkali, with a mass fraction of NaOH being 90% and a mass fraction of KOH being 10%. The mixed alkali was heated to 300° C. to a molten state to obtain a molten alkali;
(2) 1 wt % of PFOS and 1 wt % of PFOA were added to the molten alkali obtained in step (1). A total mass fraction of the perfluorinated compounds was 2 wt %, and a temperature of a molten reaction system was held at the 300° C.; and
(3) the molten reaction system was subjected to reaction for 15 min, and a resulting reaction product was cooled to room temperature. All resulting residues were dissolved in 50 mL of water. A concentration of F⁻ was determined by using an F⁻ ion selective electrode, wherein a total amount of F⁻ accounts for 97.4% of a total amount of organofluorine added in step (2), i.e. 97.4% of the perfluorinated compound has been treated by mineralization.

### Example 6

A method for mineralizing a perfluorinated compound by using a molten alkali was conducted by the following steps:
(1) NaOH was mixed with KOH to obtain a mixed alkali, with a mass fraction of NaOH being 30% and a mass fraction of KOH being 70%. The mixed alkali was heated to 150° C. to a molten state to obtain a molten alkali;
(2) 1 wt % of PFOS was added to the molten alkali obtained in step (1), and a temperature of a molten reaction system was held at the 150° C.; and
(3) the molten reaction system was subjected to reaction for 45 min, and a resulting reaction product was cooled to room temperature. All resulting residues were dissolved in 50 mL of water. A concentration of F⁻ was determined by using an F⁻ ion selective electrode, wherein a total amount of F⁻ accounts for 68.1% of a total amount of organofluorine added in step (2), i.e., 68.1% of the perfluorinated compound has been treated by mineralization.

The reactants, reaction conditions and reaction results of examples 1-6 described above are shown in Table 1.

TABLE 1
Reactants, reaction conditions and reaction results of examples 1-6

| | | Perfluorinated | | | Destruction |
|---|---|---|---|---|---|
| | | compound and its | | | rate of |
| | | mass fraction relative | Reaction | Reaction | perfluorinated |
| | Molten alkali | to molten alkali | temperature | time | compound |
| Example 1 | NaOH (30 | PFOS (1 wt %) | 150° C. | 60 min | 99.3% |
| | wt %) + KOH | | | | |
| Example 2 | NaOH (50 | PFOS (1 wt %) + | 250° C. | 20 min | 98.2% |
| | wt %) + KOH | PFHxS (2 wt %) + | | | |
| | | PFBS (2 wt %) | | | |
| Example 3 | NaOH (70 | PFBS (1 wt %) | 300° C. | 60 min | 93.5% |
| | wt %) + KOH | | | | |
| Example 4 | NaOH (20 | PFOA (1 wt %) + | 150° C. | 15 min | 99.7% |
| | wt %) + KOH | PFHxA (1 wt %) + | | | |
| | | PFBA (1 wt %) | | | |
| Example 5 | NaOH (90 | PFOS (1 wt %) + | 300° C. | 15 min | 97.4% |
| | wt %) + KOH | PFOA (1 wt %) | | | |
| Example 6 | NaOH (30 | PFOS (1 wt %) | 150° C. | 45 min | 68.1% |
| | wt %) + KOH | | | | |

It can be seen from the results of examples 1-6 that the mineralization of perfluorinated compounds could be effectively achieved by means of a heat treatment with a molten alkali and perfluorocarboxylic acids are more prone to destruction than perfluorosulfonic acids. Moreover, the higher the reaction temperature, the faster the reaction rate, and the higher the destruction rate of the perfluorinated compounds in the same period of time (examples 1, 5 and 6).

The description of the above embodiments is intended to merely aid in the understanding of the method of the present disclosure and its core concepts. It should be noted that, for those of ordinary skills in the art, various improvements and modifications could be further made to the present disclosure without departing from the principle of the present disclosure, and these improvements and modifications also fall within the scope of the claims of the present disclosure.

What is claimed is:

1. A method for mineralizing a perfluorinated compound by using a molten alkali, comprising the following steps:
mixing NaOH and KOH to obtain a mixed alkali, and heating the mixed alkali to a temperature of 150° C. to 300° C. to a molten state obtain the molten alkali;
adding the perfluorinated compound to the molten alkali to obtain a molten reaction system, and holding the molten reaction system at the temperature of 150° C. to 300° C.; and
subjecting the molten reaction system to reaction for 15 min to 60 min to mineralizing the perfluorinated compound.

2. The method for mineralizing the perfluorinated compound by using the molten alkali of claim 1, wherein a mass fraction of the NaOH in the molten alkali is in a range of 0% to 90%.

3. The method for mineralizing the perfluorinated compound by using the molten alkali of claim 2, wherein the mass fraction of the NaOH in the molten alkali is in a range of 10% to 90%.

4. The method for mineralizing the perfluorinated compound by using the molten alkali of claim 1, wherein the perfluorinated compound is at least one selected from the group consisting of perfluorooctanesulfonic acid (PFOS), perfluorohexanesulfonic acid (PFHxS), perfluorobutanesulfonic acid (PFBS), perfluorooctanoic acid (PFOA), perfluorohexanoic acid (PFHxA), and perfluorobutanoic acid (PFBA).

5. The method for mineralizing the perfluorinated compound by using the molten alkali of claim 1, wherein a mass of the perfluorinated compound is 1% to 10% of a mass of the molten alkali.

6. The method for mineralizing the perfluorinated compound by using the molten alkali of claim 5, wherein the mass of the perfluorinated compound is 1% to 5% of the mass of the molten alkali.

7. The method for mineralizing the perfluorinated compound by using the molten alkali of claim 1, wherein after the perfluorinated compound is completely mineralized, an organofluorine in the perfluorinated compound is converted to NaF or KF.

8. The method for mineralizing the perfluorinated compound by using the molten alkali of claim 1, wherein after the perfluorinated compound is completely mineralized, resulting solid residues are all dissolved in water, and a total amount of F⁻ based on a fluoride ion concentration is consistent with a total amount of fluorine in the perfluorinated compound before the reaction.
